(19) United States
(12) Patent Application Publication
(10) Pub. No.: US 2004/0128214 A1
(43) Pub. Date: Jul. 1, 2004

(54) Inventory management method, inventory management apparatus, and recording medium

(76) Inventors: Toshiharu Ishida, Atsugi-shi (JP); Yukihiro Toriyama, Mishima-shi (JP); Yasuyuki Katsuramoto, Sagamihara-shi (JP); Tetsuhiro Yamaguchi, Gotenba-shi (JP); Seiji Hiromatsu, Mishima-shi (JP); Kazuyuki Yoshida, Tokyo (JP)

Correspondence Address: MORRISON & FOERSTER LLP, 1650 TYSONS BOULEVARD, SUITE 300, MCLEAN, VA, 22102, US

(21) Appl. No.: 10/643,076

(22) Filed: Aug. 19, 2003

(30) Foreign Application Priority Data
Aug. 20, 2002 (JP) 2002-239270

(51) Int. Cl. G06F 17/60

(52) U.S. Cl. 705/28

(57) ABSTRACT

A management computer calculates a predicted inventory amount based on a sales plan amount, a warehousing amount, and a predicted inventory result, of a specific day. Then, the management computer calculates a determining period fluctuation range inventory, physical distribution inventory, and physical distribution fluctuation range inventory. Then, the management computer calculates a standard value of inventory based on the determining period fluctuation range inventory, physical distribution inventory, physical distribution fluctuation range inventory, and a safe inventory amount. Furthermore, the management computer calculates a standard value of lump-sum inventory, calculates a standard value of inventory from the standard value of inventory and standard value of lump-sum inventory, and obtains a supplement amount by the difference of the standard value of inventory and predicted inventory amount.

### BACKGROUND OF THE INVENTION

1. Field of the Invention

The present invention relates to an inventory management method and an inventory management apparatus that appropriates inventory by obtaining a standard value of inventory and supplement amount.

2. Description of the Related Art

When selling merchandise, to prevent the lacking of merchandise to be delivered to the customer who ordered that merchandise (out of stock), there is a tendency to keep extra inventory. As a result, there are cases of being forced to a halt in production for an extended period, or a sudden curtailment of production due to the excessive inventory.

It has been proposed to set a standard value of inventory which is a value that if the inventory is going to reduce even more, it will lead to out of stock, and supplementing the inventory so that the value does not go below the standard value of inventory. The Unexamined Japanese Patent Application KOKAI Publication No.H7-192068, Unexamined Japanese Patent Application KOKAI Publication No.H8-190593, Unexamined Japanese Patent Application KOKAI Publication No.H8-235274, Unexamined Japanese Patent Application KOKAI Publication No.H11-345267, and Unexamined Japanese Patent Application KOKAI Publication No.2000-84799, are some examples.

However, even in the cases where a standard value of inventory is set, and the inventory is supplied based on that value, it is difficult to always keep the inventory adequate if the interval for carrying out the management of the standard value of inventory is large. For example, when managing the standard value of inventory at a monthly rate, a situation occurs that even though it is adequate inventory at the month-end, it is excessive inventory at the middle of the month. Therefore, to prevent excessive inventory, it is preferable to manage the standard value of inventory at the shortest possible period, for example at a daily rate. However, in the aforementioned prior art, a means for managing the standard value of inventory at a daily rate has not been proposed.

### SUMMARY OF THE INVENTION

The present invention is proposed to solve the aforementioned problem. The object of the present invention is to provide an inventory management method and an inventory management apparatus and a recording medium for managing a standard value of inventory at a daily rate, and maintaining an adequate inventory amount.

To solve the aforementioned problems, the invention according to a first aspect of the present invention is an inventory management method for calculating a supplement amount of inventory at a specific day, wherein a computer comprises:

a step for calculating a sales plan amount from a standard day to the aforementioned specific day based on sales performance data that stores the sales performance, and sales plan data that stores the sales plan;

a step for predicting an inventory amount at the aforementioned specific day based on the aforementioned sales plan amount, inventory amount at the aforementioned standard day, and warehousing amount from the aforementioned standard day to the aforementioned specific day;

a step for predicting a sales amount of the period from the aforementioned specific day to the days required to deliver the merchandise passes, based on the aforementioned sales plan amount;

a step for calculating a sales fluctuation range amount by multiplying the aforementioned sales amount by a predetermined fluctuation range ratio;

a step for calculating a lower limit inventory amount of the aforementioned specific day based on the aforementioned sales amount and the aforementioned sales fluctuation range amount; and

a step for calculating a supplement amount based on inventory amount and lower limit inventory amount of the aforementioned specific day.

The aforementioned step for calculating the sales plan amount comprises:

a step for calculating a sales performance ratio of each operating day based on the aforementioned sales performance data;

a step for calculating an expected sales performance ratio of each operating day after the aforementioned standard day, based on the aforementioned sales performance ratio of the aforementioned each operating day; and

a step for calculating a sales plan amount until the aforementioned specific day based on the aforementioned expected sales performance ratio of each operating day after the standard day.

The aforementioned warehousing amount is calculated based on the aforementioned supplement amount of the aforementioned standard day to the day before the specific day.

The aforementioned specific day is a day after the soonest day possible to supplement the inventory, when there is a new order.

The aforementioned computer further comprises a step for respectively calculating a retrospective day that goes back a period, which is required to deliver the merchandise from the factory, before a delivery day of each blanket order, when there is a blanket order, and the aforementioned step for calculating the aforementioned lower limit inventory amount with the aforementioned sales fluctuation range and the aforementioned sales amount calculates the aforementioned lower limit inventory amount of the aforementioned specific day, based on each order amount of the aforementioned blanket order and the aforementioned retrospective day.

In the present invention, according to a second aspect, an inventory management apparatus, which calculates a supplement amount of inventory at a specific day, that comprises a storing unit that stores sales performance data, which stores sales performance, and sales plan data, which stores sales plan, and a controller which

calculates a sales plan amount from a standard day to the aforementioned specific day based on the aforementioned sales performance data and the aforementioned sales plan data;

predicts an inventory amount at the aforementioned specific day based on the aforementioned sales plan amount, inventory amount at the aforementioned standard day, and warehousing amount from the aforementioned standard day to the aforementioned specific day;

predicts a sales amount of the period from the aforementioned specific day to the days required to deliver the merchandise passes, based on the aforementioned sales plan amount;

calculates a sales fluctuation range amount by multiplying the aforementioned sales amount by a predetermined fluctuation range ratio;

calculates a lower limit inventory amount of the aforementioned specific day based on the aforementioned sales amount and the aforementioned sales fluctuation range amount; and

calculates a supplement amount based on inventory amount and lower limit inventory amount of the aforementioned specific day.

The aforementioned controller calculates a sales performance ratio of each operating day based on the aforementioned sales performance data, calculates an expected sales performance ratio of each operating day after the aforementioned standard day, based on the aforementioned sales performance ratio of each operating day, and calculates a sales plan amount until the aforementioned specific day based on the aforementioned expected sales performance ratio of each operating day after the aforementioned standard day.

The aforementioned warehousing amount is calculated based on the aforementioned supplement amount of the aforementioned standard day to the day before the specific day.

The aforementioned specific day is a day after the soonest day possible to supplement the inventory, when there is a new order.

The aforementioned controller calculates a retrospective day that goes back a period, which is required to deliver the merchandise from the factory, before a delivery day of each blanket order, when there is a blanket order, and calculates the aforementioned lower limit inventory amount with the aforementioned sales fluctuation range amount and the aforementioned sales amount of the aforementioned specific day, based on each order amount of the aforementioned blanket order and the aforementioned retrospective day.

In the present invention, according to a third aspect, a recording medium that records an inventory management program for calculating a supplement amount of inventory at a specific day, and the aforementioned inventory management program functions a computer as:

sales plan amount calculating means for calculating a sales plan amount from a standard day to the aforementioned specific day based on sales performance data that stores the sales performance and sales plan data that stores the sales plan;

inventory amount predicting means for predicting an inventory amount at the aforementioned specific day based on the aforementioned sales plan amount, inventory amount at the aforementioned standard day, and warehousing amount from the aforementioned standard day to the aforementioned specific day;

sales amount predicting means for predicting a sales amount of the period from the aforementioned specific day to the days required to deliver the merchandise passes, based on the aforementioned sales plan amount;

sales fluctuation range calculating means for calculating a sales fluctuation range amount by multiplying the aforementioned sales amount by a predetermined fluctuation range ratio;

lower limit inventory amount calculating means for calculating a lower limit inventory amount of the aforementioned specific day based on the aforementioned sales amount and the aforementioned sales fluctuation range amount; and

supplement amount calculating means for calculating a supplement amount based on inventory amount and lower limit inventory amount of the aforementioned specific day.

The aforementioned computer calculates a sales plan amount from a standard day to the aforementioned specific day, based on sales performance data that stores the sales performance, and sales plan data that stores the sales plan amount, and predicts an inventory amount at the aforementioned specific day based on the inventory amount at the aforementioned standard day, and the warehousing amount from the aforementioned standard day to the aforementioned specific day. Then, the aforementioned computer predicts a sales amount of the period from the aforementioned specific day to the days required to deliver the merchandise passes, based on the aforementioned sales plan amount. Furthermore, the aforementioned computer calculates a sales fluctuation range amount by multiplying the aforementioned sales amount by a predetermined fluctuation range ratio. Then, the aforementioned computer calculates a lower limit inventory amount of the aforementioned specific day based on the sales amount and sales fluctuation range amount, and calculates a supplement amount based on the inventory amount and lower limit of inventory amount of the specific day. By this, the inventory amount and the lower limit of inventory amount of the aforementioned specific day are gained, and the supplement amount can be gained based on the obtained amount. Therefore, by supplementing the inventory of merchandise based on that supplement amount, it is possible to maintain a more adequate inventory.

The aforementioned computer calculates a sales performance ratio of each operating day based on the aforementioned sales performance data. Then, the aforementioned computer calculates an expected sales performance ratio of each operating day after the standard day, based on the sales performance ratio of each operating day. Then, the aforementioned computer calculates a sales plan amount until the aforementioned specific day based on the aforementioned sales plan data and the aforementioned expected sales plan ratio of each operating day after the standard day. By this, an expected sales performance ratio after the standard day is obtained according to the sales performance ratio of each operating day, and based on the obtained expected sales performance ratio, a sales plan amount until the aforementioned specific day can be calculated. Therefore, the trend of the sales performance can be reflected to the sales plan amount until the aforementioned specific day.

A warehousing amount is an amount calculated based on the aforementioned supplement amount before the aforementioned specific day. Therefore, the warehousing amount can be predicted before the merchandise is actually stocked.

The day after the soonest day possible to supplement the inventory, when there is a new order, is applied as the specific day. Therefore, a predicted inventory sales performance amount can be gained based on a determined supplementation plan of inventory.

The aforementioned computer respectively calculates a retrospective day that goes back a period, which is required to deliver the merchandise from the factory, before a delivery day of each blanket order, when there is a blanket order. Then, the aforementioned computer calculates the lower limit inventory amount of the specific day, with the aforementioned sales fluctuation range and the aforementioned sales amount, based on each order amount of the aforementioned blanket order and the aforementioned retrospective day. Therefore, when there is a blanket order, the lower limit inventory amount corresponding to that blanket order can be gained.

### BRIEF DESCRIPTION OF THE DRAWINGS

These objects and other objects and advantages of the present invention will become more apparent upon reading of the following detailed description and the accompanying drawings in which:

FIG. 1 is a system schematic diagram of one embodiment of the present invention;

FIG. 2 is a diagram for describing the data stored in FIG. 1's inventory information storing unit;

FIG. 3 is a diagram for describing the data stored in FIG. 1's monthly sales plan information storing unit;

FIG. 4 is a diagram for describing the data stored in FIG. 1's sales performance ratio information storing unit;

FIG. 5 is a diagram for describing the data stored in FIG. 1's model information storing unit;

FIG. 6 is a diagram for describing the data stored in FIG. 1's lump-sum delivery information storing unit;

FIG. 7 is a flowchart for describing a procedure of one embodiment of the present invention;

FIG. 8 is a flowchart for describing a procedure of one embodiment of the present invention;

FIG. 9 is a flowchart for describing a procedure of one embodiment of the present invention;

FIG. 10 is a diagram for describing the calculation of the supplement amount;

FIGS. 11A, and 11B are diagrams for describing the calculation of a sales plan amount, and FIG. 11A is a diagram for describing a sales performance ratio, and FIG. 11B is a diagram for describing an expected sales performance ratio;

FIG. 12 is a diagram for describing a standard value of ordinary inventory; and

FIG. 13 is a diagram for describing a standard value of lump-sum inventory.

### DETAILED DESCRIPTION OF THE PREFERRED EMBODIMENTS

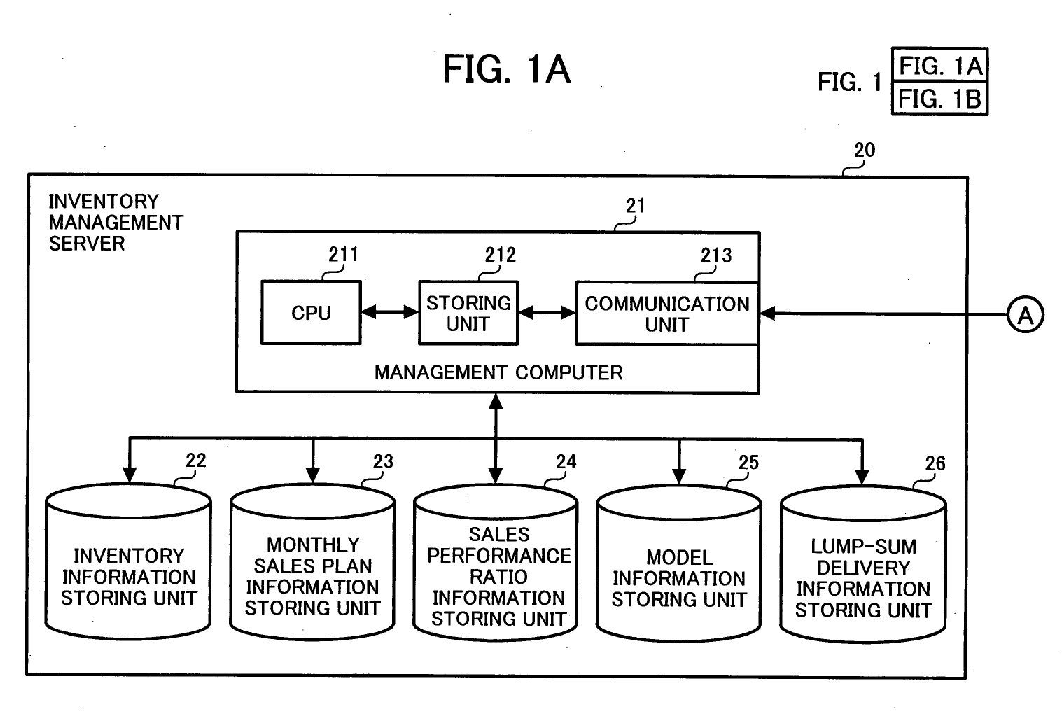

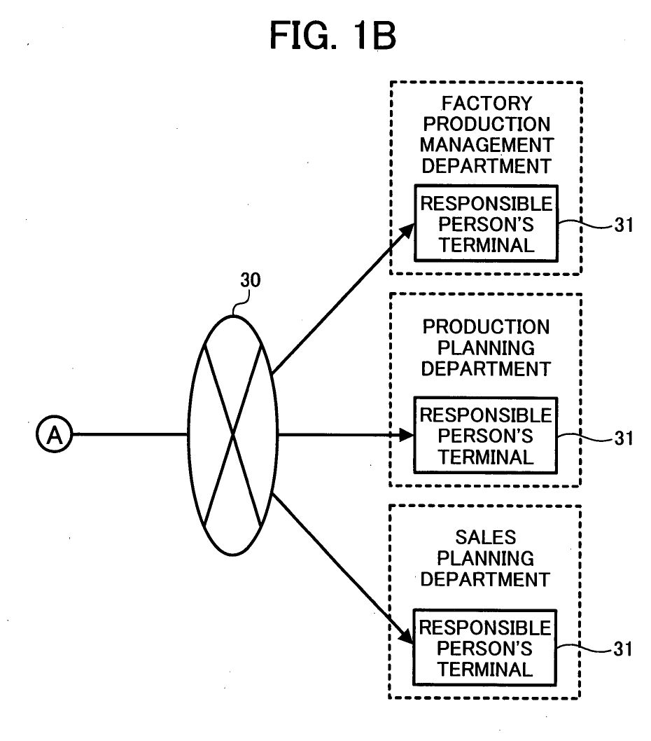

One embodiment concretizing the present invention will be described based on FIGS. 1 to 13. In this embodiment, an inventory management method and an inventory management apparatus and a recording medium for maintaining an adequate inventory amount by obtaining a standard value of inventory at a daily rate, and also obtaining a supplement amount based on a standard value of inventory. Furthermore, in this embodiment, inventory represents the total amount of merchandise from when it is shipped from the factory until it is delivered to the customer, and includes not only the number of merchandise in the stock room, but also the number of merchandise that is being transported.

As shown in FIG. 1, an inventory management server 20 is connected to a responsible person's terminal 31 placed in a factory production management department, a production planning department, and a sales planning department, through a network 30. The person in charge of the factory production management department carries out the production management etc., using the responsible person's terminal 31, following the production plan. The person in charge of the production planning department uses the responsible person's terminal 31 to carry out planning etc., of the production planning. The person in charge of the sales planning department uses the responsible person's terminal 31 to carry out adjustment etc., of the sales planning. In these cases, various lists and charts concerning production management, production planning, and sales planning are displayed to each responsible person's terminal 31. These responsible person's terminals 31 carry out inputting data, sending and receiving data among the inventory management server 20, and displaying data. Therefore, the responsible person's terminal 31 comprises control means (CPU), storing means (RAM, ROM, and hard disk, etc.,), communication means, displaying means (for example a monitor), and inputting means (for example a keyboard and a mouse), which are not shown in the drawings.

As shown in FIG. 1, the inventory management server 20 comprises a management computer 21. The management computer 21 is a computer which comprises a control unit 211 (CPU), a storing unit 212 (RAM, ROM, hard disk, etc.,), and a communication unit (a network card etc.,). By executing an inventory management program, the management computer 21 calculates the standard value of inventory, and carries out processing for calculating the supplement amount based on the standard value of inventory. Additionally, this inventory management program is comprised of various programs, and by executing these various programs, sending and receiving data, and processing data, which will be described later, are carried out. Namely, in this embodiment, this management computer 21 functions as sales plan amount calculating means, inventory amount predicting means, sales fluctuation range calculating means, sales amount predicting means, lower limit inventory amount calculating means, and supplement amount calculating means. Furthermore, the management computer 21 further functions as sales performance ratio calculating means, expected sales performance ratio calculating means, and retrospective day calculating means.

An inventory information storing unit 22, a monthly sales plan information storing unit 23, a sales performance ratio information storing unit 24, a model information storing unit 25, and a lump-sum delivery information storing unit 26, are connected to each other, and are respectively connected to the management computer 21.

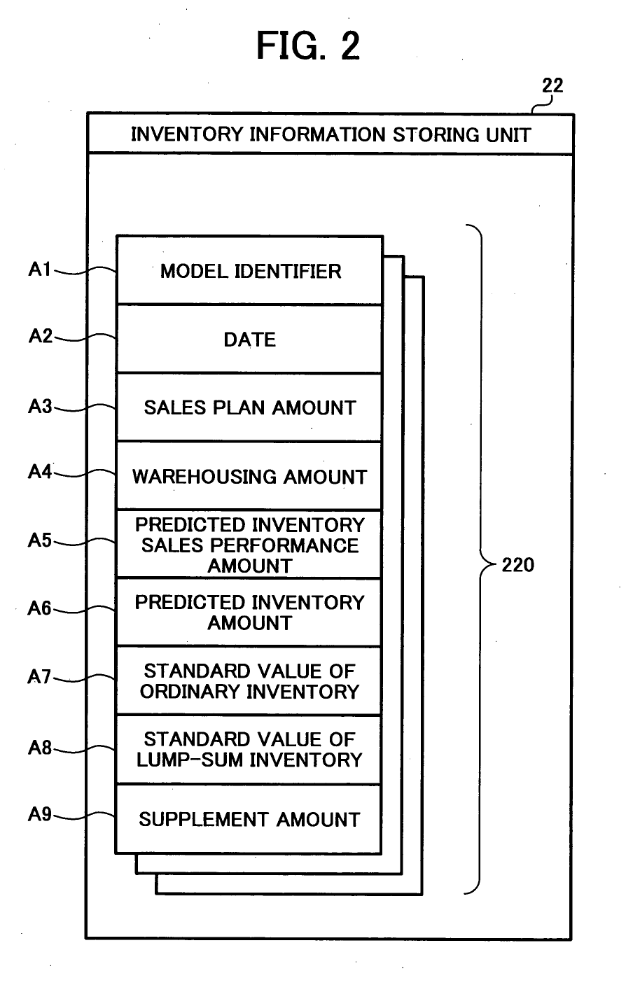

As shown in FIG. 2, in the inventory information storing unit 22, inventory information 220 is stored according to each model and date A2. In this embodiment, the inventory information 220 comprises, a model identifier A1, a date A2, a sales plan amount A3, a warehousing amount A4, a predicted inventory sales performance amount A5, a predicted inventory amount A6, a standard value of ordinary inventory A7, a standard value of lump-sum inventory A8, and a supplement amount A9. The model identifier A1 is an identifier for identifying the models of merchandise. The date A2 corresponds to every date wherein the sales plan amount A3 is calculated. The sales plan amount A3 is the sales plan amount per day. The warehousing amount A4 is the planned amount to be shipped from the factory on date A2. The predicted inventory sales performance amount A5 is the inventory amount of the day before date A2. The predicted inventory amount A6 is the predicted amount of inventory thought to be having at the time after stocking and shipping at date A2, obtained based on the sales plan amount A3, the warehousing amount A4, and the predicted inventory sales performance amount A5. The standard value of ordinary inventory is a standard value calculated based on the ordinary sales plan. Additionally, in this embodiment, when there is an order for a same model at an amount exceeding the predetermined amount, which has the same delivery date, the order is handled as a blanket order, and the orders other than the lump-sump orders are handled as ordinary orders. The standard value of lump-sum inventory A8 is the standard inventory corresponding to that blanket order when there is a blanket order. The supplement amount A9 is the amount requested to the factory for supplementation. Furthermore, the inventory information 220 is updated daily.

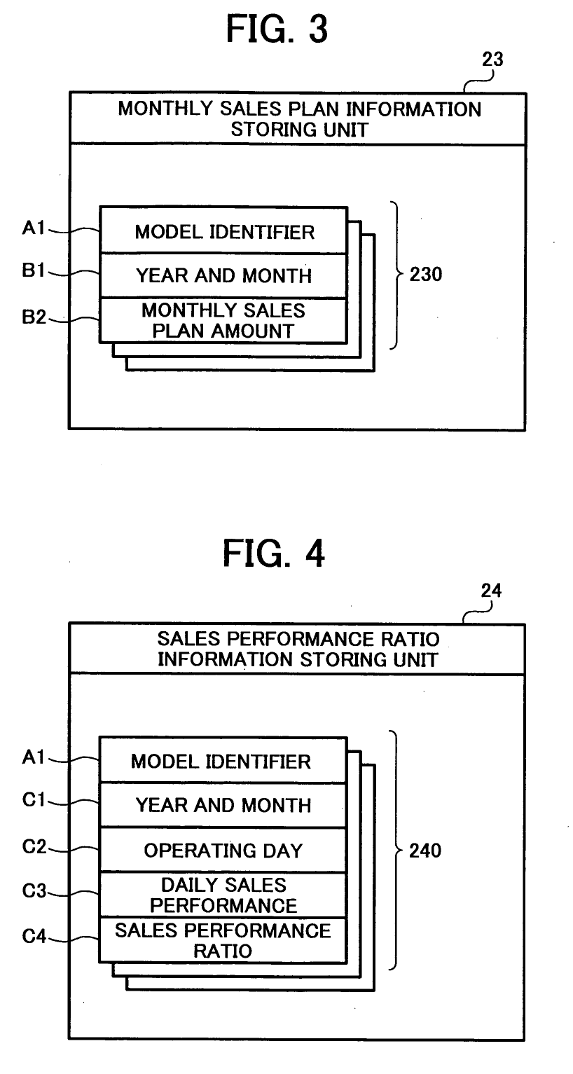

As shown in FIG. 3, in a monthly sales plan information storing unit 23, monthly sales plan information 230 is stored according to each model and year and month B1. In this embodiment, the monthly sales plan information 230 is comprised of a model identifier A1, year and month B1, and a monthly sales plan amount B2. The model identifier A1 is an identifier for identifying models. The year and month B1 is the year and month that the monthly sales plan was planned. The monthly sales plan amount B2 is the sales plan amount in the month of the aforementioned year and month B1. In this embodiment, the monthly sales plan amount B2 is obtained at the beginning of the month, after the sales performance of the last month has been determined, and is revised every two weeks, and then is updated.

As shown in FIG. 4, in the sales performance ratio information storing unit 24, sales performance ratio information 240 is stored according to each model, year and month C1, and operating day C2. In this embodiment, the sales performance ratio information 240 is comprised of a model identifier A1, year and month C1, operating day C2, a daily sales performance C3, and a sales performance ratio C4. The model identifier A1 is an identifier for identifying models. Year and month data C1 is the year and month of the past. The operating day C2 is the operating day in the aforementioned year and month C1. The daily sales performance C3 is the sales performance in the aforementioned operating day C2. The sales performance ratio C4 is the ratio of the total of the daily sales performance C3 of the aforementioned year and month C1, to the daily sales performance C3 of the aforementioned operating day C2. The model identifier A1, year and month C1 and operating day C2 is set and stored in the sales performance ratio information 240 daily. Then, after the daily sales performance C3 has been determined up to the month-end of the year and month C1, the sales performance ratio C4 is calculated and stored based on the processing which will be described later on.

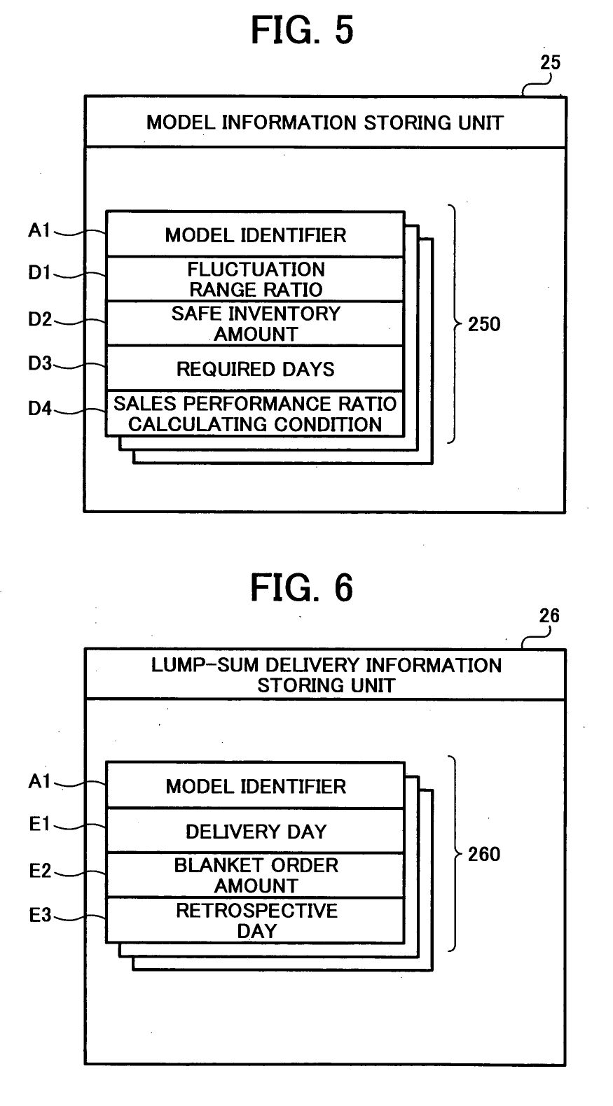

As shown in FIG. 5, in the model information storing unit 25, model information 250 is stored according to each model. In this embodiment, the model information is comprised of a model identifier A1, a fluctuation range ratio D1, a safe inventory amount D2, required days D3, and a sales performance ratio calculating condition D4. The model identifier A1 is an identifier for identifying the models of merchandise. The fluctuation range ratio D1 is a ratio of the fluctuation of the performance amount from the expected amount of the past, and in this embodiment, it is a value pre-calculated based on the past data of each model, and is in the scope of ±20 percent. The safe inventory amount D2 is an inventory amount that is prepared beforehand, so that even in a case where the actual sales increase in a large amount, it can be responded to. The required days D3 are the period of number of days necessary to deliver a merchandise to a customer after being shipped from the factory, and applies the average value calculated based on the days that were actually necessary. The sales performance ratio calculating condition D4 is a condition concerning sales performance ratio information 240, which is referred to, to calculate the sales performance ratio C4. As the sales performance ratio calculating condition D4, for example, conditions such as “same model, past three months”, “reference model (model identifier), same month of past three years”, whether it is the same model or a reference model, if it is a reference model or a model identifier A1, and the target month is displayed. This model information 250 is pre-stored before the processing of this embodiment.

As shown in FIG. 6, in the lump-sum delivery information storing unit 26, lump-sum delivery information 260 is stored according to each blanket order, and model. In this embodiment, the lump-sum delivery information 260 is comprised of a model identifier A1, a delivery day E1, a blanket order amount E2, and a retrospective day E3. The model identifier A1 is an identifier for identifying the model of merchandise. The delivery day E1 is the day when the blanket-ordered merchandise is going to be delivered to the customer. The blanket order amount E2 is the amount that was ordered collectively. The retrospective day E3 is the time limit day for shipping the merchandise, to deliver that merchandise to the customer on the delivery day E1. This lump-sum delivery information 260 is stored when there is a blanket order.

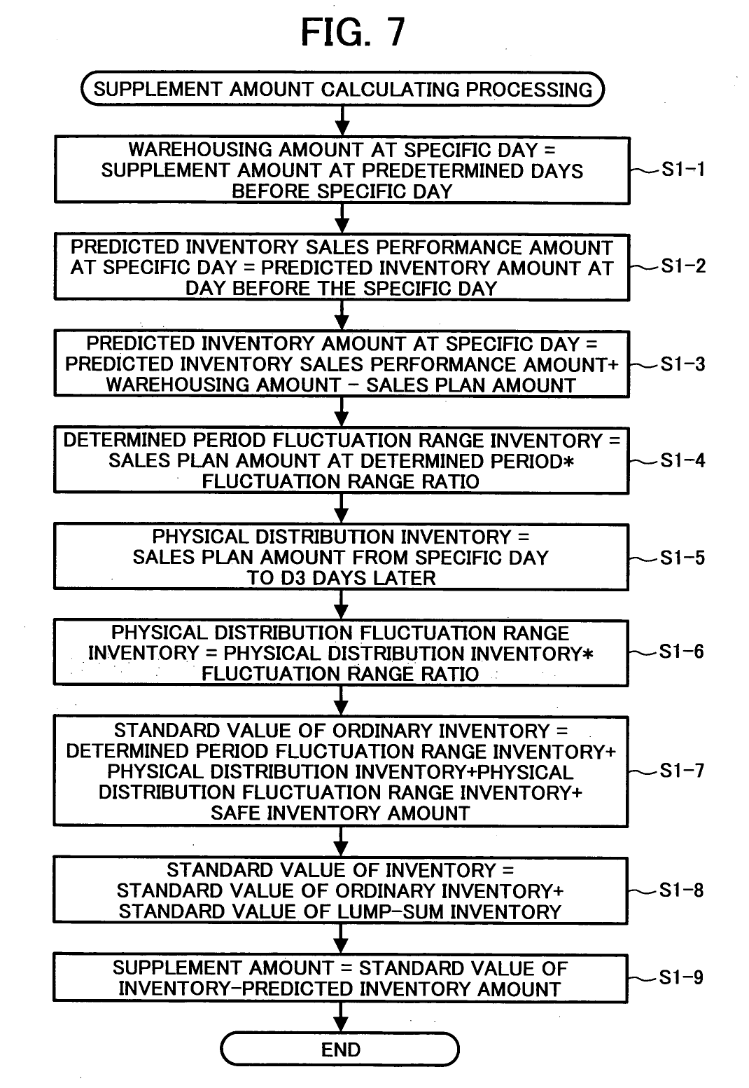

Next, in a system comprised as above, the processing of when the management computer 21 calculates the supplement amount A9 at a specific day will be described according to FIGS. 7 to 9.

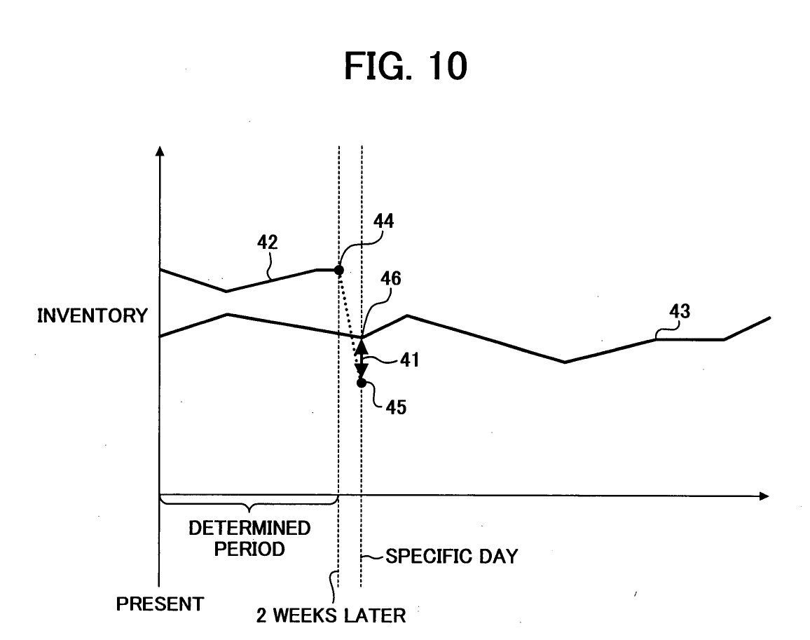

In this embodiment, concerning the period from present to two weeks ago (determining period), the production plan in the factory is determined, and based on the calculated supplement amount A9 instructions for supplementation to the factory can be carried out from the day after the determining period. Therefore, the next day after the determining period has passed is referred as the specific day, and the standard value of inventory and supplement amount A9 of the specific day are calculated. The description view of the calculation of the supplement amount A9 is shown in FIG. 10. In FIG. 10, in the determining period, an expected inventory transition 42, and a transition of standard value of inventory is determined. The expected inventory transition 42 is the transition of the predicted inventory amount A6. The transition of the standard value of inventory is the transition of standard value of inventory calculated by adding the standard value of ordinary inventory A7 and standard value of lump-sum inventory A8. Furthermore, a standard value of inventory 46 shows the standard value of inventory of the next day after the determining period has passed.

Now, the procedure for obtaining the supplement amount A9 will be described.

First, as shown in FIG. 7, in the management computer 21, the warehousing amount A4 of the specific day is obtained (step S1-l). Concretely, first, the management computer 21 seeks the date A2 of the predetermined days before the specific day. Here, the predetermined days are the days necessary to ship the merchandise from the factory, according to the instruction for supplementation. Then, the management computer 21 extracts the supplement amount A9 of the date A2 from the inventory information storing unit 22, and sets it in the inventory information 220, specified by the model identifier A1 and the date A2, as the warehousing amount A4 of the date A2.

Next, the management computer 21 obtains the predicted inventory sales performance amount A5 (Step S1-2). Concretely, first, the management computer 21 obtains the date A2 of the day before the specific day, and extracts the predicted inventory amount A6 of the day before the specific day, which is specified by the model identifier A1 and that date A2. Then, the management computer 21 sets the predicted inventory amount A6 of the day before the specific day, as the predicted inventory sales performance amount A5 in the inventory information 220 specified by the model identifier A1 and the date A2. Furthermore, the predicted inventory amount A6 corresponds to an expected inventory 44 shown in FIG. 10.

Next, the management computer 21 calculates the predicted inventory amount A6 at the specific day (Steps S1-3). To calculate the predicted inventory amount A6, the sales plan amount A3 is used.

In this case, first, the person in charge of the sales department, determines at the beginning of the month, the monthly sales plan amount B2 of the aforementioned predetermined period after that month according to each model based on the sales performance of the past, after the daily sales performance C3 is determined in each operating day up until the month before. The person in charge of the aforementioned sales department inputs the monthly sales plan amount B2 into the management computer 21.

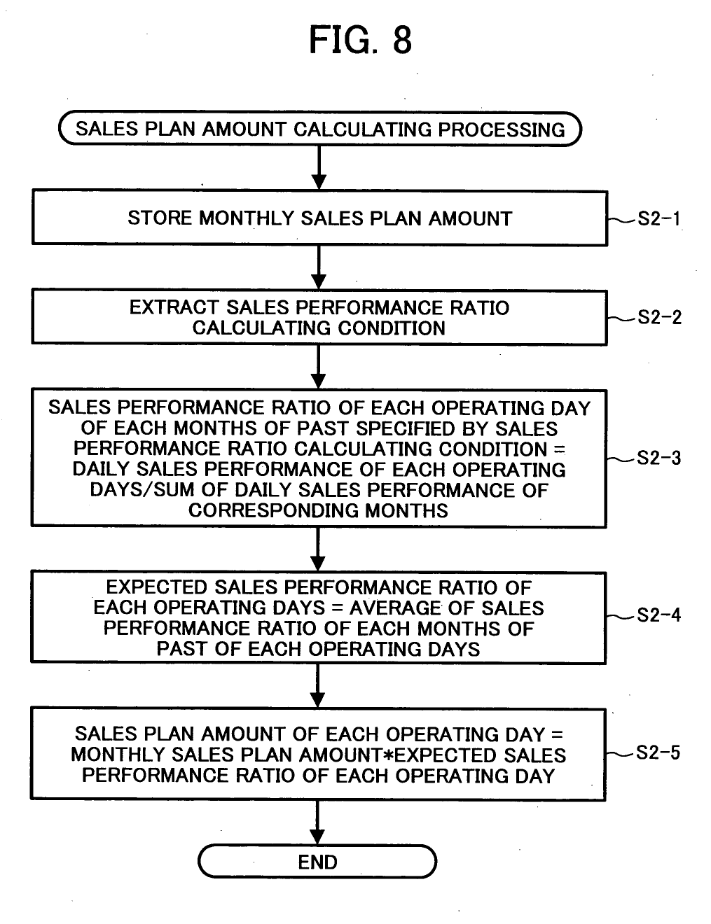

Next, according to FIG. 8, the procedure for obtaining the sales plan amount A3 will be described. As shown in FIG. 8, the management computer 21 stores the inputted monthly sales plan amount B2 (Step S2-1). Then, the management computer 21 extracts the sales performance ratio calculating condition D4 from the model information storing unit 25 by the model identifier A1 (Step S2-2).

Next, the management computer 21 calculates the sales performance ratio C4 according to the operating day C2 of each month of the past, specified by the sales performance ratio calculating condition D4 (Step S2-3). Concretely, the management computer 21 extracts the sales performance ratio information 240 from the sales performance ratio information storing unit 24, based on the sales performance ratio calculating condition D4, and calculates the monthly sales performance amount concerning each month of the past specified in the sales performance ratio calculating condition D4. Then, the management computer 21 calculates the sales performance ratio C4 of each operating day C2s by dividing the daily sales performance C3 of each operating day C2s by the aforementioned monthly sales performance amount, concerning the aforementioned each month.

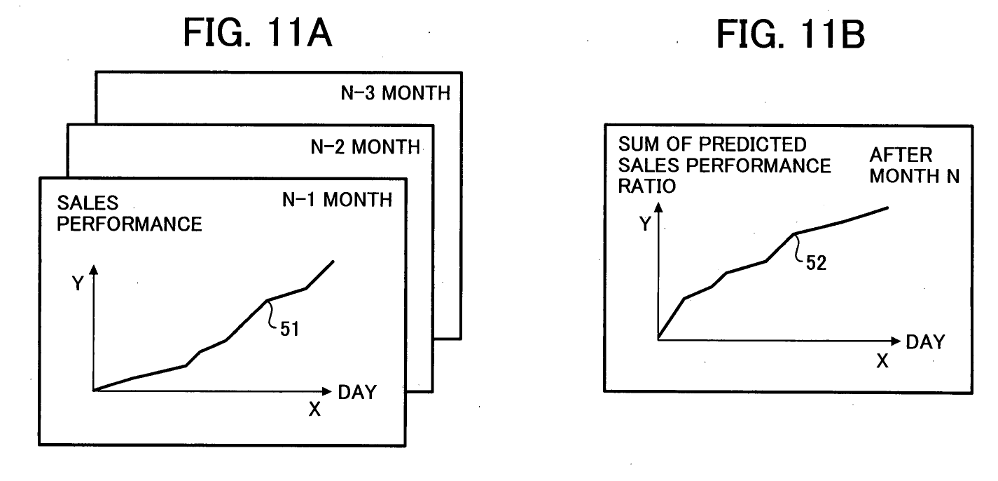

In this embodiment, the sales performance ratio calculating condition D4 is “same model, past three months”, and the management computer 21 extracts the sales performance ratio information 240 of the last three month of that model identifier A1. Then, the management computer 21, as aforementioned, calculates the sales performance ratio C4 of each operating day concerning the sales performance ratio information 240. For example, if a month before the month that the specific day belongs to is expressed in a line chart, wherein the operating day C2 is an x-coordinate, and the monthly sum total of the sales performance ratio C4 is a y-coordinate, a sales performance sum total 51, shown in FIG. 11A is gained.

By calculating the average of the sales performance ratio C4 of the aforementioned each moth according to each operating day C2s, the management computer 21 obtains the expected sales performance ratio of each operating day C2s (Step S2-4). In this embodiment, based on the sales performance ratio C4 of each operating day C2s of each month of the past three month, the expected sales performance ratio after this month is calculated. If this case is expressed as a line chart, wherein the date A2 is an x-coordinate, and the sum total of the expected sales performance is a y-coordinate, an expected sales performance sum total 52 is gained.

Next, by multiplying the monthly sales plan amount B2 by the expected sales performance ratio of each operating day C2s, the sales plan amount A3 of each operating day is calculated (Step S2-5). Then the management computer 21 sets the sales plan amount A3 in the inventory information 220, specified by the model identifier A1 and date A2 of the specific day. Additionally, this sales plan amount A3 is calculated in the beginning of the month after the daily sales performance C3 of each operating day C2s of the last month has been determined, concerning a predetermined period (for example, 6 months), after this month. Furthermore, if the monthly sales plan amount B2 is reviewed, the sales plan amount A3 is calculated respectively.

Then, the management computer 21 calculates the predicted inventory amount A6 by subtracting the sales plan amount A3 from the total of the predicted inventory sales performance amount A5 and warehousing amount A4. By this, a predicted inventory amount 45 shown in FIG. 10 is obtained.

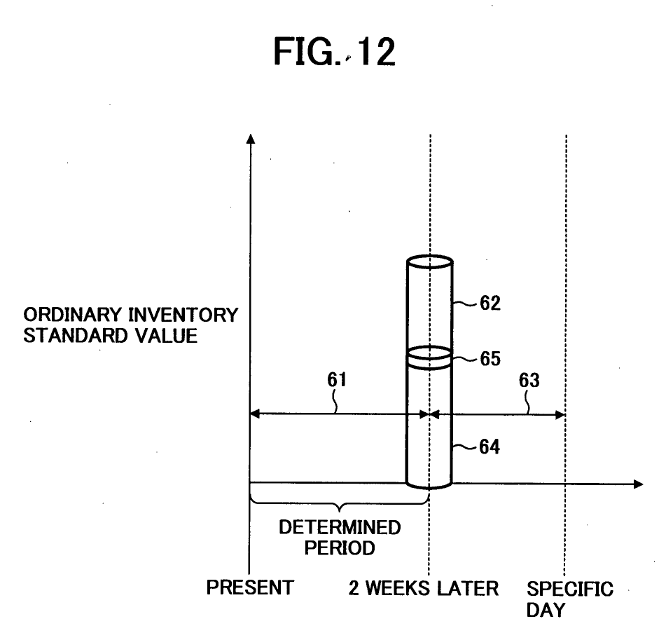

Next, the management computer 21 calculates the determining period fluctuation range inventory as the sales fluctuation range, by [determining period fluctuation range inventory=the total of the sales plan amount A3 at determining period*fluctuation range ratio] (Step S1-4). Here, the determining period fluctuation range inventory is the fluctuation of inventory by the sales plan amount A3 to the actual sales amount fluctuating at the determining period wherein the warehousing amount A4 is determined (two weeks from the present date). Concretely, the management computer 21 extracts the fluctuation range ratio D1 from the model information storing unit 25, by the model identifier A1. Then, the management computer 21 extracts the sales plan amount A3 of the predetermined period, which is the period two weeks from the present date, by the model identifier A1 and the date A2 of the determining period. Then, by multiplying the total of the sales plan amount A3 by the fluctuation range ratio D1, the management computer 21 calculates the determining period fluctuation range inventory. By this, in FIG. 12, a determining period fluctuation range inventory 62 is calculated by multiplying the total of the sales plan amount A3 at a determining time 61, by the fluctuation range ratio D1.

Next, the management computer 21 calculates a physical distribution inventory by the total of sales plan amount A3 at the period from a specific day to required days D3 from the specific day (Step S1-5). Here, the physical distribution inventory is the amount of merchandise, which is in a situation from being shipped from the factory until it is delivered to the customer. Here, as the required days D3, the period from the merchandise being shipped from the factory to the merchandise being delivered, is applied. Then, the management computer 21 calculates the physical distribution inventory as the predicted sales performance amount by the total of the sales plan amount A3 of that period. Concretely, the management computer 21 extracts the required days D3 from the model information storing unit 25 by the model identifier A1. Then, the management computer 21 extracts the sales plan amount A3 of the date A2 that falls on the period of a specific day to required days D3 after the specific day, of the target model identifier A1, and calculates the physical distribution inventory based on the aforementioned expression. By this, in FIG. 12, a physical distribution inventory 64 is calculated as the total of sales plan amount A3 at a physical distribution period 63, which is the period from the specific day to required days D3 after the specific day.

Then, the management computer 21 calculates the physical distribution fluctuation range inventory as the sales fluctuation range by [physical distribution fluctuation range inventory=physical distribution inventory*fluctuation range ratio D1] (Step S1-6). Here, the physical distribution fluctuation range inventory is the fluctuation range of inventory fluctuating from the sales plan amount A3 to the actual sales amount. By this, in FIG. 12, a physical distribution fluctuation range inventory 65 is calculated as the value multiplying the physical distribution inventory 64 by the fluctuation range ratio D1.

Next, the management computer 21 calculates the standard value of ordinary inventory A7 by [standard value of ordinary inventory A7=determining period fluctuation range inventory+physical distribution inventory+physical distribution fluctuation range inventory+safe inventory amount D2] (Step S1-7). Concretely, the management computer 21 extracts the safe inventory amount D2 from the model information storing unit 25 by the model identifier A1. The, the management computer 21 calculates the standard value of ordinary inventory A7 following the aforementioned expression.

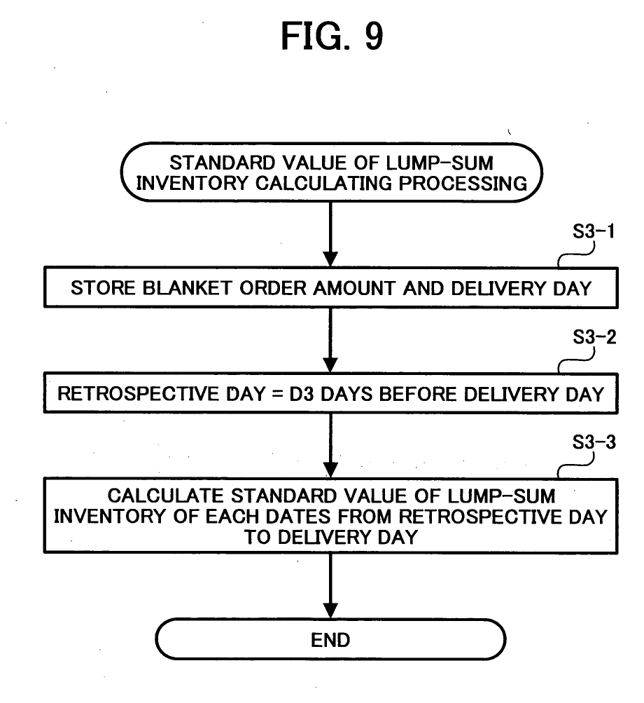

Next, the management computer 21 calculates the standard value of inventory as the lower limit inventory amount by [standard value of inventory=standard value of ordinary inventory A7+standard value of lump-sum inventory A8] (Step S1-8). Additionally, the standard value of lump-sum inventory A8 is obtained when there is a blanket order, and is set in the inventory information 220. Next, the processing procedure for obtaining the standard value of lump-sum inventory A8 will be described according to FIG. 9.

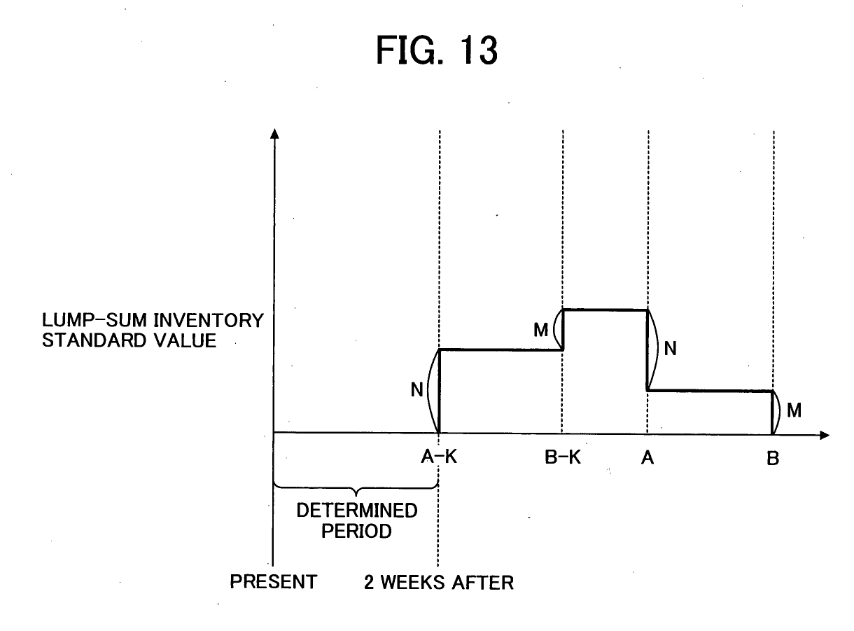

The blanket order is carried out by specifying the delivery day E1 and blanket order amount E2 of the order of target model. Then, when there is a blanket order, the person in charge for the sales department inputs the model identifier A1, delivery day E1 and blanket order amount E2 to the management computer 21, using the responsible person's terminal 31. As shown in FIG. 9, the management computer 21 stores the model identifier A1, delivery day E1, and blanket order amount E2 in the lump-sum delivery information storing unit 26 (Step S3-1). For example, it is assumed that there is a blanket order wherein the delivery day E1 is A, and the blanket order amount E2 is n, and a blanket order wherein the delivery day E1 is B, and the blanket order amount E2 is m. The description view of the standard value of lump-sum inventory A8 of this case is shown in FIG. 13.

Next, the management computer 21 extracts the required days D3 from the model information storing unit 25 by the model identifier A1, and obtains the retrospective day E3 as the date of the required days D3 before the delivery day E1. For example, if the required days D3 is k-days, when the delivery day E1 is A, the retrospective day E3 is k-days before A (A-k). If the delivery day E1 is B, the retrospective day E3 is k-days before B (B-k).

Next, the management computer 21 calculates the standard value of lump-sum inventory A8 by adding the blanket order amount E2 of each blanket order, concerning each date of the period from the retrospective day E3 of each blanket order to the delivery day E1 (Step S3-3). In the above case, the standard value of lump-sum inventory A8 of the period from k-days before A (A-k) to k-days before B (B-k) becomes n. The standard value of lump-sum inventory A8 of the period from k-days before B (B-k) to A becomes n+m. And, the standard value of lump-sum inventory A8 of the period from the next day of A to B becomes m.

When the standard value of lump-sum inventory A8 is calculated in this way, the management computer 21 sets the standard value of lump-sum inventory A8 at the corresponding inventory information 220. Then, the management computer 21, applying the standard value of lump-sum inventory A8 obtained in this way, calculates the standard value of inventory at the date A2 which becomes the specific day, according to the aforementioned expression. By this, the standard value of inventory 46 is obtained.

Additionally, by respectively forwarding by one day, the date A2 which becomes the specific day, and carrying out the processing of the aforementioned steps S1-1 to S1-8, the management computer 21 obtains the standard value of the future. Therefore, as shown in FIG. 10, it is possible to draw a transition of standard value of inventory 43.

Next, the management computer 21 calculates the supplement amount A9 by [supplement amount A9=standard value of inventory−predicted inventory amount A6] (Step S1-9). By this, a difference 41 shown in FIG. 10 is obtained as the supplement amount A9.

The supplement amount A9, obtained in this way, is applied when the person in charge for the production planning department carries out the production planning. Additionally, various information in the form of lists or graphs is displayed based on each data of the inventory information 220, in the responsible person's terminal 31 which each person in charge of the factory production management department, production planning department, and sales planning department use. Each person in charge of the factory production management department, production planning department, and sales planning department respectively carry out factory production management, production planning, and sales planning, based on the various information displayed in the responsible person's terminal 31. Additionally, the person in charge of the sales planning department checks the chart representing the inventory situation, and the chart representing the actual sales performance, displayed in the responsible person's terminal 31, and reviews the sales plan even at the middle of the month (for example, every two weeks).

According to this embodiment, effects shown below can be gained.

In the above embodiment, the management computer 21 calculates the sales plan amount A3 at a specific day and then calculates the predicted inventory amount A6 at the specific day, based on the sales plan amount A3, warehousing amount A4, and predicted inventory sales performance amount A5. Then, the management computer 21 calculates the determining period fluctuation range inventory, the physical distribution inventory, and the physical distribution fluctuation range inventory, and then calculates the standard value of ordinary inventory A7 based on the determining period fluctuation range inventory, the physical distribution inventory, and the physical distribution fluctuation range inventory. Furthermore, the management computer 21 calculates the standard value of lump-sum inventory A8, calculates the standard value of inventory by the standard value of ordinary inventory A17 and standard value of lump-sum inventory A8, and obtains the supplement amount from the difference of standard value of inventory and the predicted inventory amount A6. Therefore, the standard value of inventory is calculated based on the sales plan amount A3, warehousing amount A4, and predicted inventory sales performance amount A5 at the specific day, and the supplement amount A9 can be obtained by the standard value of inventory calculated above. Therefore, by supplementing the inventory of merchandise based on the supplement amount A9, a more adequate inventory can be maintained. Namely, daily inventory management becomes possible, and excessive inventory relying on predicted demand can be prevented.

In the above embodiment, the management computer 21 calculates the sales performance ratio C4 of each operating day C2s to the monthly sales performance amount of a predetermined month of the past. Then, the management computer 21 calculates the expected sales performance ratio of each operating day C2s after the present month, based on the sales performance ratio C4 of each operating day C2s in the predetermined month of the past. Then, the management computer 21 calculates the sales plan amount A3 of the specific day based on the monthly sales plan amount B2 of the month that the specific day belongs to, and the expected sales performance ratio of each operating day C2s of that month. Therefore, the expected sales performance ratio of the month that the specific day belong to is obtained based on the sales performance ratio C4 of the monthly sales performance amount of the predetermined month of the past to each operating day C2s, and based on the expected sales performance ratio, the sales plan amount A3 of the specific day is calculated. Therefore, the trend of the sales performance at the predetermined month of the past can be reflected to the sales plan amount A3 of the specific day.

In the above embodiment, the warehousing amount A4 is an amount determined based on the aforementioned supplement amount of the past. Therefore, the warehousing amount A4 can be obtained before the merchandise is actually shipped from the factory and is handled as inventory.

In the above embodiment, the predicted inventory amount A6 of the day before the specific day is used as the predicted inventory sales performance amount A5. Therefore, by obtaining the predicted inventory amount A6 of the day before the specific day, the predicted inventory sales performance amount A5 of the specific day can be obtained.

In the above embodiment, when there is a blanket order, the management computer 21 calculates the date from the delivery day E1 of that blanket order to the days before the required days D3, as the retrospective days E3. Then, the management computer 21 calculates the total of the blanket order amount E2 of the date of the period from retrospective day E3 to the delivery day E1 as the standard value of lump-sum inventory A8. Then, the management computer 21 obtains the total of the standard value of ordinary inventory A7 and standard value of lump-sum inventory A8 as the standard value of inventory. Therefore, the standard value of inventory wherein the blanket order is added can be obtained when there is a blanket order.

In the above embodiment, the sales performance ratio C4 is obtained based on the daily sales performance C3 of the predetermined month of the past shown in the sales performance ratio calculating condition D4 of each model, and the average of each month becomes the expected sales performance ratio. Therefore, the month that becomes the standard for calculating the expected sales performance ratio can be chosen, according to the sales trend of each model, and a more accurate expected sales performance ratio and sales plan amount A3 can be obtained, according to model.

In the above embodiment, following the calculated expected sales performance ratio, the sales plan amount A3 is obtained by dividing the monthly sales plan amount B2 according to the operating day C2. Therefore, the monthly sales plan amount B2 determined monthly, can be divided according to the operating day C2. In some models, the sales trend of each month is not even according to the operating day C2, but even in those cases, the sales plan amount A3 that is in line with the actual sales trend can be obtained. Also, because the sales plan amount A3 is obtained according to each operating day C2s, it is possible to stock merchandise in accordance with the delivering time to the customer, and inventory amount can be reduced. For example, if the sales trend of each month is a case where the sales of merchandise concentrates at the end of the month, the inventory can be adjusted so that the necessary inventory at the end of the month, wherein the sales increase, is ensured. Therefore, having meaningless inventory decreases, and the whole inventory can be decreased.

In the above embodiment, the determining period fluctuation range inventory of the determining period from the present date to two weeks later is obtained, and when calculating the standard value of ordinary inventory A7, the determining period fluctuation range inventory is used. Therefore, concerning the determining period, when the range fluctuates from the sales plan amount A3 to the actual sales amount, the standard value of ordinary inventory A7 can be obtained adding the fluctuation range.

In the above embodiment, the total of the sales plan amount A3 of the period from the specific day to the required days D3 after the specific day, is obtained as the physical distribution inventory. Then, the value multiplying the physical distribution inventory by the fluctuation range ratio D1 is obtained as the physical distribution fluctuation range inventory, and the physical distribution fluctuation range inventory is used to calculate the standard value of ordinary inventory A7. Therefore, concerning the amount of merchandise until the merchandise is shipped from the factory and delivered to the customer, when the range fluctuates from the sales plan amount A3 to the actual sales amount, the standard value of ordinary inventory A7 can be obtained adding the fluctuating range.

In the above embodiment, the fluctuation range ratio D1, used to obtain the determining period fluctuation inventory and the physical distribution fluctuation range inventory, is a value obtained according to each model based on the data of the past. Therefore, the determining period fluctuation inventory and the physical distribution fluctuation range inventory can be obtained according to the trend of the fluctuation range of each model, and a supplement amount A9 of a higher accuracy can be gained.

In the above embodiment, the difference of the standard value of inventory at the specific day and the predicted inventory amount A6 is obtained as the supplement amount A9. Therefore, the supplement amount A9 can be obtained in accordance with the move of the market.

In the above embodiment, the responsible person's terminal 31, which the person in charge of the factory production management department, the production planning department, and the sales planning department respectively use, is connected to the management computer 21, and displays various information based on each data stored in the storing units 22 to 26. Therefore, the person in charge of these departments can refer to the shared data, and promote mutual understanding smoothly among them.

Additionally, the above embodiment may be modified as the below manner.

In the above embodiment, the standard value of inventory was gained adding the safe inventory amount D2, but the safe inventory amount D2 may not be applied in calculating the standard value of inventory.

In the above embodiment, the determining period fluctuation range inventory and physical distribution inventory was calculated as the sales fluctuation range, and the standard value of ordinary inventory A7 was calculated using the determining period fluctuation range inventory and physical distribution inventory. This may be changed, and the sales fluctuation range may be gained by a different method.

In the above embodiment, the supplement amount A9 of the required days D3 before the specific day was used as the warehousing amount A4. This may be changed wherein the warehousing amount A4 is an amount decided by the person in charge of the production planning department based on the required days D3 before the specific day. By doing so, if the supplement amount A9 and the actual amount decided by the person in charge of the production planning department differs, the expected actual amount to be shipped from the factory may be used as the warehousing amount A4 at the specific day.

As described above, according to the present invention, it is possible to manage the standard value of inventory daily, and maintain an adequate inventory amount.

The present invention can be used in a computer apparatus that carries out inventory management.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2002-239270 filed on Aug. 20, 2002 and including specification, claims, drawings and summary. The disclosure of the above Japanese Patent Application is incorporated herein by reference in its entirety.

What is claimed is:

1. An inventory management method that calculates a supplement amount of inventory at a specific day, wherein a computer comprises:
a step for calculating a sales plan amount from a standard day to said specific day based on sales performance data that stores the sales performance, and sales plan data that stores the sales plan;
a step for predicting an inventory amount at said specific day based on said sales plan amount, inventory amount at said standard day, and warehousing amount from said standard day to said specific day;
a step for predicting a sales amount of the period from said specific day to the days required to deliver the merchandise passes, based on said sales plan amount;
a step for calculating a sales fluctuation range amount by multiplying said sales amount by a predetermined fluctuation range ratio;
a step for calculating a lower limit inventory amount of said specific day based on said sales amount and said sales fluctuation range amount; and
a step for calculating a supplement amount based on inventory amount and lower limit inventory amount of said specific day.

2. The inventory management method according to claim 1, wherein said step for calculating the sales plan amount comprises:
a step for calculating a sales performance ratio of each operating day based on said sales performance data;
a step for calculating an expected sales performance ratio of each operating day after the standard day, based on said sales performance ratio of each operating day; and
a step for calculating a sales plan amount until said specific day based on said expected sales performance ratio of each operating day after the standard day.

3. The inventory management method according to claim 1, wherein said warehousing amount is calculated based on said supplement amount of said standard day to the day before the specific day.

4. The inventory management method according to claim 1, wherein said specific day is a day after the soonest day possible to supplement the inventory, when there is a new order.

5. The inventory management method according to claim 1, wherein said computer further comprises a step for respectively calculating a retrospective day that goes back a period, which is required to deliver the merchandise from the factory, before a delivery day of each blanket order, when there is a blanket order, and said step for calculating said lower limit inventory amount, calculates with said sales fluctuation range and said sales amount the lower limit inventory amount at said specific day, based on each order amount and said retrospective day of said blanket order.

6. An inventory management apparatus, which calculates a supplement amount of inventory at a specific day, that comprises a storing unit that stores sales performance data, which stores sales performance, and sale plan data, which stores sales plan, and a controller which:
calculates a sales plan amount from a standard day to said specific day based on said sales performance data and said sales plan data;
predicts an inventory amount at said specific day based on said sales plan amount, inventory amount at said standard day, and warehousing amount from said standard day to said specific day;
predicts a sales amount of the period from said specific day to the days required to deliver the merchandise passes, based on said sales plan amount;
calculates a sales fluctuation range amount by multiplying said sales amount by a predetermined fluctuation range ratio;
calculates a lower limit inventory amount at said specific day based on said sales amount and said sales fluctuation range amount; and
calculates a supplement amount based on inventory amount and lower limit inventory amount of said specific day.

7. The inventory management apparatus according to claim 6, wherein said controller calculates a sales performance ratio of each operating day based on said sales performance data, calculates an expected sales performance ratio of each operating day after the standard day, based on said sales performance ratio of each operating day, and calculates a sales plan amount until said specific day based on said expected sales performance ratio of each operating day after the standard day.

8. The inventory management apparatus according to claim 6, wherein said warehousing amount is calculated based on said supplement amount of said standard day to the day before the specific day.

9. The inventory management apparatus according to claim 6, wherein said specific day is a day after the soonest day possible to supplement the inventory, when there is a new order.

10. The inventory management apparatus according to claim 6, wherein said controller calculates a retrospective day that goes back a period, which is required to deliver the merchandise from the factory, before a delivery day of each blanket order, when there is a blanket order, and calculates with said sales fluctuation range and said sales amount the lower limit inventory amount at said specific day, based on each order amount and said retrospective day of said blanket order.

11. A recording medium, which records an inventory management program for calculating a supplement amount of inventory at a specific day, wherein said inventory management program functions a computer as:
sales plan amount calculating means for calculating a sales plan amount from a standard day to said specific day based on sales performance data that stores the sales performance, and sales plan data that stores the sales plan;
inventory amount predicting means for predicting an inventory amount at said specific day based on said sales plan amount, inventory amount at said standard day, and warehousing amount from said standard day to said specific day;
sales amount predicting means for predicting a sales amount of the period from said specific day to the days required to deliver the merchandise passes, based on said sales plan amount;
sales fluctuation range calculating means for calculating a sales fluctuation range amount by multiplying said sales amount by a predetermined fluctuation range ratio;
lower limit inventory amount calculating means for calculating a lower limit inventory amount at said specific day based on said sales amount and said sales fluctuation range amount; and
supplement amount calculating means for calculating a supplement amount based on inventory amount and lower limit inventory amount of said specific day.

12. The recording medium according to claim 11, which functions said sales plan amount calculating means as:
sales performance ratio calculating means for calculating a safes performance ratio of each operating day based on said sales performance data;
expected sales performance ratio calculating means for calculating an expected sales performance ratio of each operating day after the standard day, based on said sales performance ratio of each operating day; and
sales plan amount calculating means for calculating a sales plan amount until said specific day based on said expected sales performance ratio of each operating day after the standard day.

13. The recoding medium according to claim 11, wherein said warehousing amount is calculated based on said supplement amount of said standard day to the day before the specific day.

14. The recording medium according to claim 11, wherein said specific day is a day after the soonest day possible to supplement the inventory, when there is a new order.

15. The recording medium according to claim 11, which further functions said computer as retrospective day calculating means for respectively calculating a retrospective day that goes back a period, which is required to deliver the merchandise from the factory, before a delivery day of each blanket order, when there is a blanket order, and functions said lower limit inventory amount means as means for calculating with said sales fluctuation range and said sales amount, the lower limit inventory amount of said specific day, based on each order amount and said retrospective day of said blanket order.
